(19) United States
(12) Patent Application Publication
(10) Pub. No.: US 2025/0254085 A1
(43) Pub. Date: Aug. 7, 2025

(54) RELAY DEVICE AND IN-VEHICLE NETWORK SYSTEM

(71) Applicant: TOYOTA JIDOSHA KABUSHIKI KAISHA, Toyota-shi (JP)

(72) Inventor: Naoya KOSHIMAE, Toyota-shi (JP)

(73) Assignee: TOYOTA JIDOSHA KABUSHIKI KAISHA, Toyota-shi (JP)

(21) Appl. No.: 19/011,824

(22) Filed: Jan. 7, 2025

(30) Foreign Application Priority Data
Feb. 2, 2024 (JP) 2024-014832

(51) Int. Cl. H04L 41/0668; H04L 12/40; H04W 4/48; H04W 88/04

(52) U.S. Cl. CPC H04L 41/0668; H04L 12/40; H04W 4/48; H04W 88/04

(57) ABSTRACT

The in-vehicle network system includes a first device, a second device, and a third device as ECU having a network management function. The second device performs failure determination to determine that the first device has failed when periodic reception of a message periodically transmitted by the first device is interrupted. The third device has a partial network function in addition to the network management function. The relay device relays messages exchanged between the first communication bus connected to the first device and the second communication bus connected to the second device and the third device. The relay device acquires state information including information indicating whether the first device is in a standby state or an operation state. Then, the relay device transmits the acquired state information to the second device.

### CROSS-REFERENCE TO RELATED APPLICATION

This application claims priority to Japanese Patent Application No. 2024-014832 filed on Feb. 2, 2024, incorporated herein by reference in its entirety.

### BACKGROUND

### 1. Technical Field

The disclosure relates to a relay device and an in-vehicle network system.

### 2. Description of Related Art

Japanese Unexamined Patent Application Publication No. 2023-109566 (JP 2023-109566 A) discloses an in-vehicle network system. The in-vehicle network system is constituted of a plurality of Electronic Control Units (ECUs). Hereinafter, the electronic control unit will be described as an ECU. When a message is received from another ECU, an ECU that confirms a destination address of the message and an ECU that does not confirm the destination address of the message are both present in the plurality of ECUs.

### SUMMARY

An operation state in which communication with another ECU is possible, and a standby state in which communication is stopped and power consumption is reduced, are present in the ECU. The ECU has a network management function that shifts from the standby state to the operation state, when operation is requested through the message. Hereinafter, the network management function will be described as an NM function. Also, an ECU having a partial network function and an ECU not having the partial network function are present in ECUs having an NM function. Hereinafter, the partial network function will be described as a PN function.

The ECU having a PN function transmits a PN message that contains information indicating a destination address. The PN message is transmitted in order to set another ECU having a PN function to the operation state. The ECU having a PN function confirms the destination address of the message, when the PN message is received. Also, the ECU having a PN function becomes the operation state only when the message is a message addressed to itself.

The ECU not having a PN function transmits an NM message. The NM message is transmitted in order to set another ECU not having a PN function to the operation state. Even if the received message is an NM message or a PN message, the ECU not having a PN function becomes the operation state without confirming the destination address.

In an in-vehicle network system, both the ECU having a PN function and the ECU not having a PN function may be connected to one communication bus. The ECU not having a PN function, which is connected to the communication bus, becomes the operation state by receiving a PN message, even if an NM message is not transmitted. At this time, the ECU not having a PN function, which is connected to another communication bus, may become the standby state in order for an NM message to not be transmitted.

In this way, the ECU not having a PN function may become the operation state, even if another ECU not having a PN function becomes the standby state. The ECU having an NM function includes a function that determines an ECU of a monitoring target has failed when a periodic reception of a message from the ECU of a monitoring target is interrupted. Accordingly, when only some of the ECUs become the operation state, the ECU not having a PN function, which is in the operation state, erroneously determines that the ECU of a monitoring target, which is in the standby state, has failed.

A relay device for solving the problem is applied to an in-vehicle network system. The in-vehicle network system includes,
as an electronic control unit having a network management function that shifts from a standby state to an operation state when operation is requested through a message, the standby state being when communication is not performed and the operation state being when communication is able to be performed,
a first device,
a second device, and
a third device.
   In the in-vehicle network system, the second device executes a failure determination that determines the first device has failed when a periodic reception of the message is interrupted, the message being periodically transmitted by the first device. In the in-vehicle network system, the third device has, in addition to the network management function, a partial network function that does not shift from the standby state to the operation state when operation is requested through the message and when the message is not addressed to itself.
   The in-vehicle network system includes
a first communication bus connected to the first device, and
a second communication bus connected to the second device and the third device.
   The relay device relays the message exchanged between the first communication bus and the second communication bus in the in-vehicle network system. The relay device acquires state information that includes information indicating whether the first device is in either the standby state or the operation state. Also, the relay device transmits the acquired state information to the second device.

An in-vehicle network system for solving the problem includes,
as an electronic control unit having a network management function that shifts from a standby state to an operation state when operation is requested through a message, the standby state being when communication is not performed and the operation state being when communication is able to be performed,
a first device,
a second device, and
a third device. In the in-vehicle network system, the second device executes a failure determination that determines the first device has failed when a periodic reception of the message is interrupted, the message being periodically transmitted by the first device. In the in-vehicle network system, the third device has, in addition to the network management function, a partial network function that does not shift from the standby state to the operation state when operation is requested through the message and when the message is not addressed to itself. The in-vehicle network system includes
a first communication bus connected to the first device,
a second communication bus connected to the second device and the third device, and a relay device.
   In the in-vehicle network system, the relay device relays the message exchanged between the first communication bus and the second communication bus. In the in-vehicle network system, the relay device acquires state information that includes information indicating whether the first device is in either the standby state or the operation state. Also, in the in-vehicle network system, the relay device transmits the acquired state information to the second device. In the in-vehicle network system, when the second device receives the state information indicating that the first device is in the standby state during execution of the failure determination,
the second device stops the failure determination for the first device.

The relay device and the in-vehicle network system can suppress an erroneous determination of a failure by the second device that is an ECU not having a PN function.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of an in-vehicle network system including a relay device according to an embodiment;

FIG. 2 is a schematic diagram illustrating a mode in which the relay device according to the embodiment shifts the ECU in the first communication bus to the standby state;

FIG. 3 is a table showing a list of state information of an ECU not having a PN function stored in the relay device according to the embodiment; and

FIG. 4 is a sequence diagram illustrating an aspect of communication in the in-vehicle network system including the relay device according to the embodiment.

### DETAILED DESCRIPTION OF EMBODIMENTS

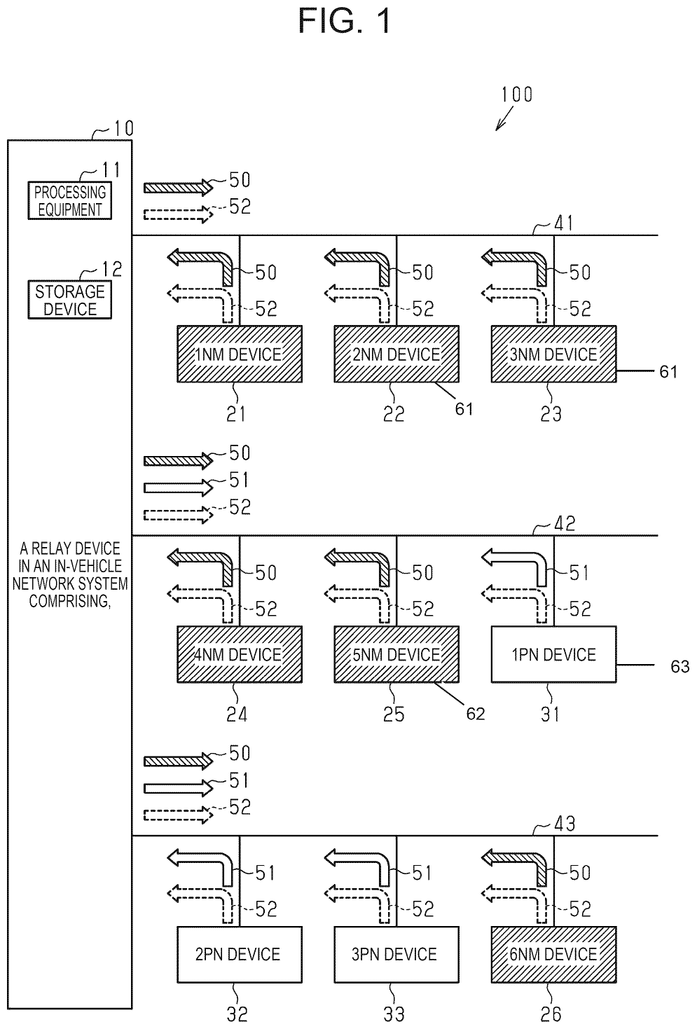

Hereinafter, an embodiment of a relay device will be described with reference to FIG. 1 to FIG. 4.

### Configuration of In-Vehicle Network System 100

As illustrated in FIG. 1, the in-vehicle network system 100 includes a plurality of electronic control units (ECU: Electronic Control Unit). Hereinafter, the electronic control unit will be described as an ECU. ECU included in the in-vehicle network system 100 is divided into an ECU having an NM function and a relay device 10. In FIG. 1, each ECU is represented by a square.

ECU having an NM function shifts from the standby state in which the communication is not performed to the operation state in which the communication is enabled when the operation is requested through the message. In the ECU having an NM function, there are an ECU having a PN function and an ECU not having a PN function.

In the in-vehicle network system 100, the ECU having a PN function is the first PN device 31, the second PN device 32, and the third PN device 33.

In the in-vehicle network system 100, an ECU not having a PN function is the first NM device 21, the second NM device 22, the third NM device 23, the fourth NM device 24, the fifth NM device 25, and the sixth NM device 26.

As illustrated in FIG. 1, the in-vehicle network system 100 includes a first communication bus 41, a second communication bus 42, and a third communication bus 43. The first communication bus 41 is connected to the first NM device 21, the second NM device 22, and the third NM device 23. The second communication bus 42 is connected to the fourth NM device 24, the fifth NM device 25, and the first PN device 31. The third communication bus 43 is connected to the second PN device 32, the third PN device 33, and the sixth NM device 26.

ECU in the in-vehicle network system 100 is connected so as to be capable of communication by transmission and reception of messages via a communication bus. In the in-vehicle network system 100, the first NM device 21, the second NM device 22, and the third NM device 23 transmit and receive messages via the first communication bus 41. In the in-vehicle network system 100, the fourth NM device 24, the fifth NM device 25, and the first PN device 31 transmit and receive messages via the second communication bus 42. In the in-vehicle network system 100, the second PN device 32, the third PN device 33, and the sixth NM device 26 transmit and receive messages via the third communication bus 43.

As illustrated in FIG. 1, the relay device 10 includes a storage device 12 in which a program is stored, and a processing device 11 that executes a program stored in the storage device 12 to execute various processes. The processing device 11 includes a processor.

In the in-vehicle network system 100, the relay device 10 is connected to all of the first communication bus 41, the second communication bus 42, and the third communication bus 43. The relay device 10 relays messages exchanged between the first communication bus 41, the second communication bus 42, and the third communication bus 43. For example, the relay device 10 receives the message transmitted by the first NM device 21 through the first communication bus 41. Then, the relay device 10 transmits the message received from the first NM device 21 toward ECU connected to the second communication bus 42 and the third communication bus 43.

ECU in the in-vehicle network system 100 implements certain functions in vehicles while communicating with other ECU. At this time, the combination of ECU for realizing a particular function in the in-vehicle network system 100 varies depending on the realized function. In addition, in the in-vehicle network system 100, an ECU having a PN function communicates with another ECU having a PN function to realize a particular function. On the other hand, in the in-vehicle network system 100, an ECU not having a PN function communicates with another ECU not having a PN function to realize a particular function.

When implementing a particular function, ECU in the in-vehicle network system 100 requests other ECU that need to be operated in order to realize the function to operate through message.

As shown in FIG. 1, a PN message 51 is transmitted by an ECU having a PN function. PN message 51 is a message transmitted in order for an ECU having a PN function to require the operation of another ECU having a PN function. At this time, PN message 51 is transmitted by an ECU having a PN function to which the identity of the destination address ECU requesting the operation is attached.

On the other hand, as shown in FIG. 1, an ECU not having a PN function transmits an NM message 50. NM message 50 is a message transmitted in order to require the operation of another ECU not having a PN function by an ECU not having a PN function. At this time, unlike the ECU having a PN function, an ECU not having a PN function transmits NM message 50 without adding the identity of the destination address ECU requesting the operation.

The ECU having a PN function among ECU that has received the message requesting the operation confirms the destination address of the received message. Then, when the message is PN message 51 to which the message is assigned as a destination address, the ECU having a PN function shifts from the standby state to the operation state. On the other hand, when the message is PN message 51 to which the ECU having a PN function does not have NM message 50 or its own identity as the destination address, it does not shift to the operation state.

In an ECU that receives a message requesting operation, an ECU not having a PN function shifts from the standby state to the operation state without confirming the destination address of the received message. That is, when a message requesting activation is received, even if the message is NM message 50 or PN message 51, an ECU not having a PN function shifts from the standby state to the operation state.

As described above, when the ECU having a PN function transmits the PN message 51, the ECU not having a PN function and the ECU having a PN function that is the destination address of PN message 51 among ECU that has received the message are shifted to the operation state. On the other hand, when an ECU not having a PN function transmits NM message 50, only an ECU not having a PN function among ECU that received the message shifts to the operation state.

As described above, the relay device 10 relays messages between communication buses. The relay device 10 transmits the PN message 51 transmitted by the ECU having a PN function to a communication bus to which another ECU having a PN function is connected. For example, when the first PN device 31 transmits the PN message 51, the relay device 10 transmits the PN message 51 to the third communication bus 43, which is the communication bus to which the second PN device 32 and the third PN device 33 are connected.

In addition, the relay device 10 transmits the NM message 50 transmitted by the ECU not having a PN function to the communication bus to which the other ECU not having a PN function is connected. For example, when the first NM device 21 transmits NM message 50, the relay device 10 transmits NM message 50 to the fourth NM device 24, the second communication bus 42, and the third communication bus 43. The second communication bus 42 is connected to the fifth NM device 25. The third communication bus 43 is connected to the sixth NM device 26.

The relay device 10 also transmits NM message 50 and PN message 51. While receiving PN message 51 from another ECU, the relay device 10 relays the PN message 51 and transmits the PN message 51 to the communication bus to which the ECU having a PN function is connected. Therefore, as shown in FIG. 1, the relay device 10 transmits the PN message 51 toward the second communication bus 42 and the third communication bus 43 while receiving the PN message 51 from another ECU.

While receiving NM message 50 from another ECU, the relay device 10 relays NM message 50 and transmits NM message 50 to the communication bus to which the ECU not having a PN function is connected. Therefore, as illustrated in FIG. 1, the relay device 10 transmits NM message 50 to the first communication bus 41, the second communication bus 42, and the third communication bus 43 while receiving NM message 50 from another ECU.

As illustrated in FIG. 1, ECU in the in-vehicle network system 100 transmits a control message 52 in addition to PN message 51 and NM message 50. The control message 52 is a message transmitted by ECU to exchange data required to realize a particular function. For example, ECU may be configured to transmit, to the other ECU, information of the rotational speed of the vehicle as control messages. In the present embodiment, the control message 52 is a generic term excluding a message requesting operation among messages transmitted by the respective ECU in the in-vehicle network system 100.

In the in-vehicle network system 100, the second NM device 22 and the third NM device 23 periodically transmit control message 52. In the in-vehicle network system 100, the fifth NM device 25 receives a control message 52 periodically transmitted by the second NM device 22 and the third NM device 23. The fifth NM device 25 determines that the second NM device 22 has failed when the periodic reception of the control message 52 from the second NM device 22 is interrupted. Further, the fifth NM device 25 determines that the third NM device 23 has failed when the periodic reception of the control message 52 from the third NM device 23 is interrupted. As described above, the fifth NM device 25 performs failure determination on the second NM device 22 and the third NM device 23.

Hereinafter, in the in-vehicle network system 100, an ECU for periodically transmitting the control message 52 in order to have the failure determination executed is referred to as a first device 61. In the in-vehicle network system 100, the second NM device 22 and the third NM device 23 are the first devices 61.

Hereinafter, in the in-vehicle network system 100, when the periodic reception of the control message 52 that the first device 61 periodically transmits is interrupted, ECU that the first device 61 determines that a failure is referred to as the second device 62. In the in-vehicle network system 100, the fifth NM device 25 is the second device 62.

Hereinafter, in the in-vehicle network system 100, an ECU having a PN function connected to the same communication bus as the second device 62 is referred to as a third device 63. In the in-vehicle network system 100, the first PN device 31 is the third device 63.

### Mode of Shifting ECU to Standby State in In-Vehicle Network System 100

As described above, when implementing a particular function, ECU requests the other ECU that needs to operate in order to realize the function to operate through message. ECU periodically send a message requesting operation until the implementation of a particular function is completed. Then, in ECU where the implementation of the particular function is completed, the transmission of the message requesting the operation is stopped.

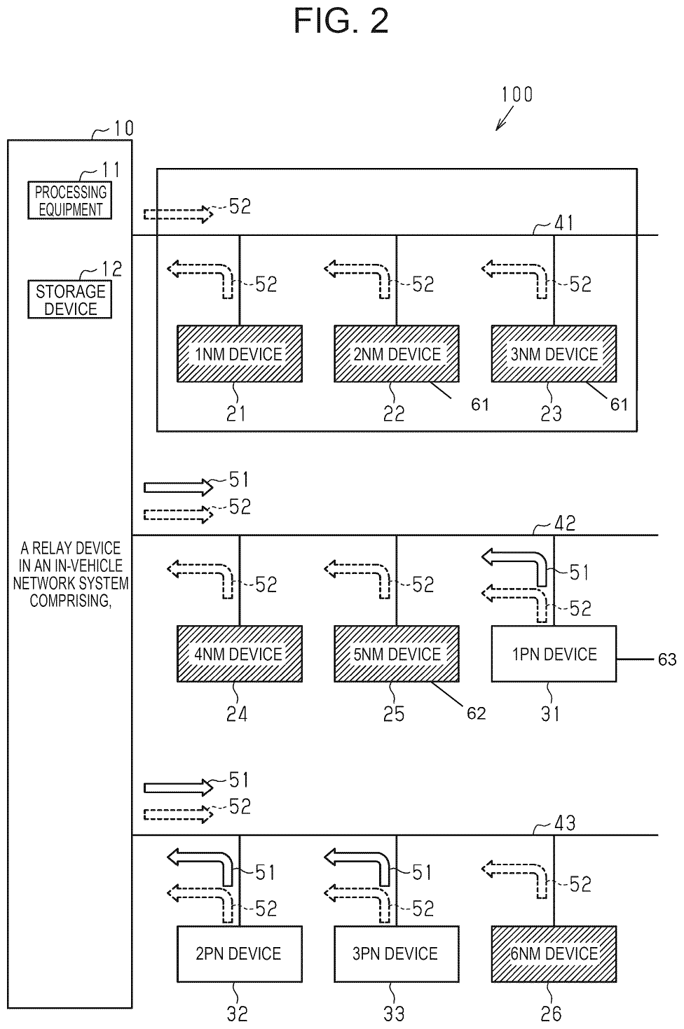

FIG. 2 illustrates an aspect of the in-vehicle network system 100 illustrated in FIG. 1 in which an ECU not having a PN function has completed implementation of a particular function. That is, in FIG. 2, all ECUs that do not have a PN function have stopped transmitting the NM message 50.

When all PN functions-free ECU stop transmitting the NM message 50, the relay device 10 does not receive NM message 50 from another ECU. The relay device 10 that no longer receives NM message 50 stops transmitting the NM message 50 itself.

ECU that has shifted to the operation state continues the operation state for a certain period of time each time a message requesting the operation is received. Then, when a message requesting operation is no longer received from another ECU, the process shifts from the operation state to the standby state.

In the case shown in FIG. 2, ECU connected to the first communication bus 41 does not receive NM message 50 because all ECUs that do not have PN function have stopped transmitting the NM message 50. Further, as described above, the relay device 10 does not relay PN message 51 to ECU connected to the first communication bus 41. Thus, in the case illustrated in FIG. 2, ECU connected to the first communication bus 41 does not receive a message requesting operation. Therefore, ECU included in the area surrounded by the rectangle in FIG. 2 is shifted from the operation state to the standby state. As described above, in the case illustrated in FIG. 2, the first device 61 has shifted to the standby state.

On the other hand, in the case illustrated in FIG. 2, ECU connected to the second communication bus 42 does not receive NM message 50 as in ECU connected to the first communication bus 41. However, as shown in FIG. 2, a first PN device 31, which is an ECU having a PN function, is connected to the second communication bus 42. Therefore, PN message 51 is transmitted to ECU connected to the second communication bus 42. Thus, in the case illustrated in FIG. 2, ECU connected to the second communication bus 42 continues to receive a message requesting operation even if the NM message 50 is no longer transmitted. Therefore, in the case illustrated in FIG. 2, the fourth NM device 24, which is an ECU not having a PN function, and the fifth NM device 25 continue the operation state even if the NM message 50 is not transmitted. Thus, in the case shown in FIG. 2, the second device 62 connected to the second communication bus 42 remains operation state even if the NM message 50 is no longer transmitted because the third device 63 is connected to the same bus.

In FIG. 2, the first device 61 is in the standby state, while the second device 62 is in the operation state. In such a case, the first device 61 that has shifted to the standby state does not periodically transmit the control message 52. At this time, the second device 62 that has stopped receiving the control message 52 erroneously determines that the first device 61 has failed.

In order to suppress such erroneous determination, the relay device 10 transmits the state information to the second device 62. The state information is information including information indicating whether the first device 61 is in a standby state or an operation state.

### State Information Acquired by Relay Device 10

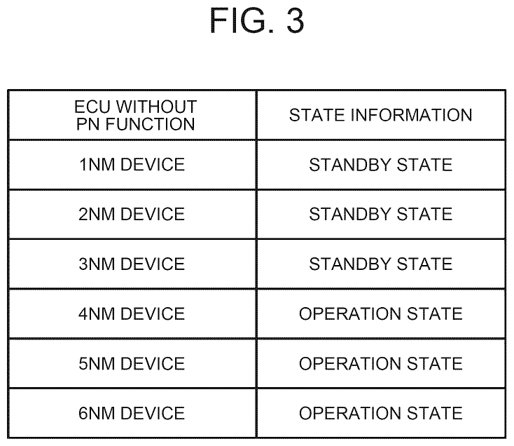

FIG. 3 shows a summary of whether the ECU not having a PN function in the in-vehicle network system 100 is in a standby state or in an operation state. The relay device 10 stores a list as illustrated in FIG. 3 in the storage device 12. As illustrated in FIG. 3, the relay device 10 stores, in the storage device 12, information indicating whether an ECU not having a PN function is in a standby state or in an operation state, as state information.

As described above, the relay device 10 transmits the PN message 51 to the communication bus to which the ECU having a PN function is connected. On the other hand, the relay device 10 transmits NM message 50 to the communication bus to which an ECU not having a PN function is connected. In this way, the relay device 10 transmits a message requesting operation according to ECU connected to the communication bus.

The relay device 10 acquires state information of each ECU having no PN function based on a message requesting operation that the relay device transmits for each communication bus. For example, in the case illustrated in FIG. 2, the relay device 10 stops transmitting a message requesting operation toward the first communication bus 41. At this time, the relay device 10 detects that the first NM device 21, the second NM device 22, and the third NM device 23 connected to the first communication bus 41 have shifted to the standby state. Then, the relay device 10 determines that the first NM device 21, the second NM device 22, and the third NM device 23 are in the standby state, and acquires the state information.

On the other hand, in the case illustrated in FIG. 2, the relay device 10 continues to transmit PN message 51 toward the second communication bus 42 and the third communication bus 43. For this reason, the relay device 10 acquires the state information regarding the fourth NM device 24 and the fifth NM device 25 connected to the second communication bus 42 and the sixth NM device 26 connected to the third communication bus 43 as being in the operation state.

As illustrated in FIG. 3, the relay device 10 lists the acquired state information for each ECU having no PN function in the in-vehicle network system 100. The ECU not having a PN function includes a second NM device 22 that is the first device 61 and a third NM device 23. Therefore, the relay device 10 acquires the state information for each of the first devices 61, and then summarizes the acquired plurality of state information in a list.

### Communication Flow for Suppressing Erroneous Determination in Failure Determination by Second Device 62

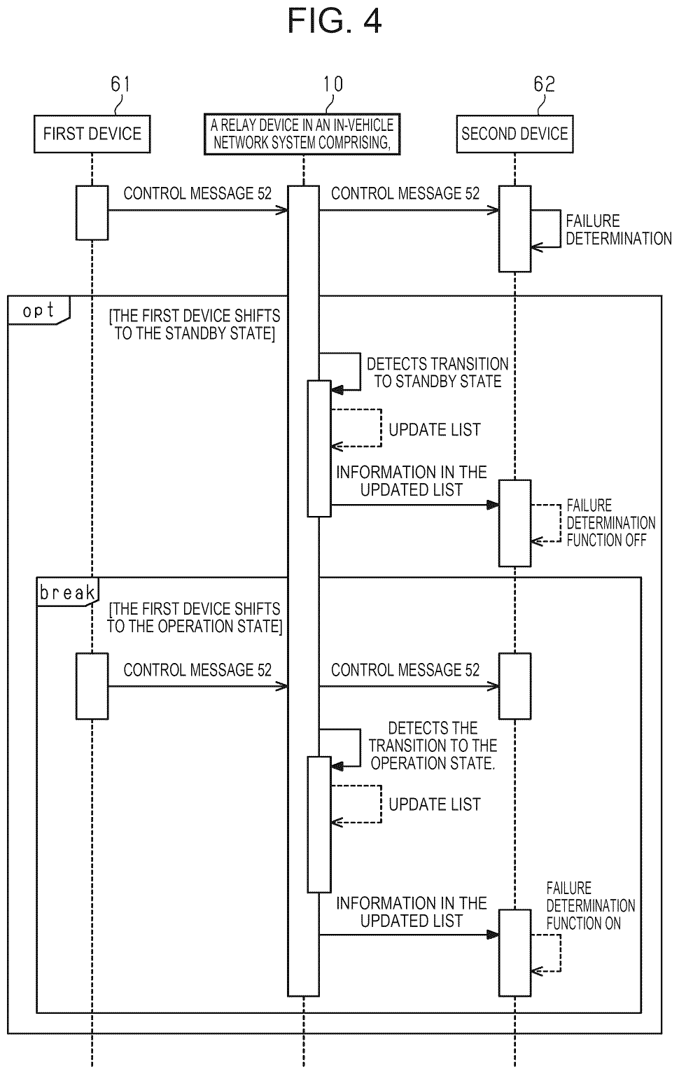

FIG. 4 illustrates an aspect of communication performed by the relay device 10, the first device 61, and the second device 62 for failure determination by the first device 61 in the in-vehicle network system 100.

As illustrated in the upper part of FIG. 4, the first device 61 periodically transmits the control message 52 during the operation state. Upon receiving the control message 52 from the first device 61, the relay device 10 relays the control message 52 to the second device 62.

After receiving the control message 52 from the relay device 10, the second device 62 performs failure determination. At this time, the second device 62 determines that the first device 61 has not failed by receiving the control message 52 from the first device 61.

As illustrated in the middle stage of FIG. 4, when the first device 61 transitions to the standby state, the first device 61 does not transmit the control message 52 that has been periodically transmitted.

When the first device 61 shifts to the standby state, the relay device 10 stops transmitting a message requesting operation toward the first communication bus 41 to which the first device 61 is connected. The relay device 10 detects that the first device 61 has shifted to the standby state based on the stop of transmission of the message. Then, the relay device 10 that has detected that the first device 61 has shifted to the standby state updates the list shown in FIG. 3. That is, the relay device 10 lists the second NM device 22 and the third NM device 23, which are the first devices 61, as being in the standby state. In the in-vehicle network system 100, when the first device 61 shifts to the standby state, the first NM device 21 also shifts to the standby state, and therefore, the first NM device 21 is also recorded as being in the standby state in the same manner.

As illustrated in the middle part of FIG. 4, the relay device 10 having updated the list transmits information of the updated list to the second device 62. The updated information includes both ECU in which the state information is updated and ECU in which the state information is not updated. Note that the updated information may include only the state information in an ECU where the state information is updated. In this way, the relay device 10 collectively transmits the acquired plurality of pieces of state information to the second device 62 in one list.

The updated list is transmitted to all ECUs in the in-vehicle network system 100 including the second device 62. Note that the updated information may be transmitted only to an ECU where failure determination is performed in an ECU where the state information is updated.

If the first device 61 is in the operation state, the relay device 10 transmits the information of the updated list to the timing at which the control message 52 is transmitted to the second device 62. That is, when the first device 61 transitions from the operation state to the standby state, the relay device 10 transmits the state information in place of the first device 61 at a timing when the first device 61 should transmit the control message 52 next time.

As illustrated in the middle part of FIG. 4, the second device 62 that has received the information of the updated list recognizes that the first device 61 has shifted to the standby state from the information. Then, the second device 62 turns off the function of the failure determination. As described above, when the received state information indicates that the first device 61 is in the standby state, the second device 62 stops the failure determination for the first device 61.

As shown in the lower part of FIG. 4, when the first device 61 transitions from the standby state to the operation state, the first device 61 resumes periodic transmission of the control message 52 to the second device 62. Upon receiving the control message 52 from the first device 61, the relay device 10 relays the control message 52 to the second device 62.

When the first device 61 shifts to the operation state, the relay device 10 resumes transmission of a message requesting the operation toward the first communication bus 41 to which the first device 61 is connected. The relay device 10 detects that the first device 61 has shifted to the operation state based on the resumption of transmission of the message. Then, the relay device 10 that has detected that the first device 61 has shifted to the operation state updates the list shown in FIG. 3. That is, the relay device 10 lists the second NM device 22 and the third NM device 23, which are the first devices 61, as being in operation state. In the in-vehicle network system 100, when the first device 61 shifts to the operation state, the first NM device 21 also shifts to the operation state, and therefore, the first NM device 21 is also recorded as being in the operation state in the same manner.

As illustrated in the lower part of FIG. 4, the relay device 10 having updated the list transmits information of the updated list to the second device 62. The second device 62 that has received the information of the updated list recognizes that the first device 61 has shifted to the operation state from the information. Then, the second device 62 turns on the function of failure determination. In this way, when the state information is received from the relay device 10 after stopping the failure determination, if the received state information indicates that the first device 61 is in the operation state, the second device 62 resumes the failure determination for the first device.

### Operations of Present Embodiment

The relay device 10 transmits, to the second device 62, whether the first device 61 is in the standby state or in the operation state. That is, the relay device 10 causes the second device 62 to perform failure determination of the first device 61 in consideration of the state information from the relay device 10.

### Effects of Present Embodiment

(1) The relay device 10 can suppress erroneous determination of a failure by the second device 62.
(2) In the in-vehicle network system 100, the first communication bus 41 is connected to a plurality of first devices 61. The relay device 10 acquires state information for each of the first devices 61. Then, the relay device 10 collectively transmits the acquired plurality of pieces of state information to the second device 62 in one list.

The relay device 10 lists the state information of the plurality of first devices 61 and transmits the list to the second device 62. Accordingly, the relay device 10 can cause the second device 62 to simultaneously grasp the state information of the plurality of first devices 61.
(3) When the first device 61 shifts from the operation state to the standby state, the relay device 10 transmits state information indicating that the first device 61 is in the standby state to the second device 62 instead of the first device 61. At this time, the relay device 10 transmits the state information at a timing at which the first device 61 that has periodically transmitted the control message 52 should transmit the control message 52 next.

When the first device 61 shifts to the standby state, the relay device 10 transmits the state information at a timing at which the first device 61 originally transmits the control message 52 for failure determination. Accordingly, the relay device 10 can notify the second device 62 that the first device 61 has shifted to the standby state.
(4) The in-vehicle network system 100 includes a first device 61, a second device 62, and a third device 63 as an ECU having a network management function. An ECU having a network management function transitions from a standby state in which communication is not performed to an operation state in which communication is enabled when an operation is requested through message. In the in-vehicle network system 100, the second device 62 performs failure determination to determine that the first device 61 has failed when the periodic reception of the control message 52 periodically transmitted by the first device 61 is interrupted. In the in-vehicle network system 100, the third device 63 has a partial network function in addition to the network management function. The third device 63 having the partial network function does not transition from the standby state to the operation state when the operation is requested through the message and the message is not addressed to itself. The in-vehicle network system 100 includes a first communication bus 41 connected to the first device 61, a second communication bus 42 connected to the second device 62 and the third device 63, and a relay device 10. In the in-vehicle network system 100, the relay device 10 relays messages exchanged between the first communication bus 41 and the second communication bus 42. In the in-vehicle network system 100, the relay device 10 acquires state information including information indicating whether the first device 61 is in a standby state or an operation state. Then, in the in-vehicle network system 100, the relay device 10 transmits the acquired state information to the second device 62. In the in-vehicle network system 100, when the state information indicating that the first device 61 is in the standby state is received during execution of the failure determination, the second device 62 stops the failure determination with respect to the first device 61.

In the in-vehicle network system 100, the second device 62 recognizes that the state of the first device 61 that is the target of failure determination has shifted to the standby state based on the state information from the relay device 10. Then, the second device 62 stops the failure determination for the first device 61. Accordingly, the in-vehicle network system 100 can suppress erroneous determination of a failure by the second device 62.
(5) When the state information is received from the relay device 10 after the failure determination is stopped in the in-vehicle network system 100, the received state information may indicate that the first device 61 is in an operation state. In this case, the second device 62 resumes the failure determination for the first device 61.

In the in-vehicle network system 100, the second device 62 recognizes that the first device 61 that is the target of failure determination has shifted to the operation state based on the state information from the relay device 10. Then, the second device 62 resumes the failure determination of the first device 61. As a result, the in-vehicle network system 100 can perform the failure determination again for the first device 61 that has shifted from the standby state to the operation state.

### Modifications

The present embodiment can be realized with the following modifications. The present embodiment and the following modifications can be combined with each other within a technically consistent range to be realized.

If the in-vehicle network system 100 includes the first communication bus 41 including the first device 61, the second communication bus 42 including the second device 62 and the third device 63, and the relay device 10, the number of communication buses and the number of connected ECU are not limited to the above-described embodiments. The topology of the in-vehicle network system 100 is not limited to the above-described embodiment.

In the in-vehicle network system 100 according to the above-described embodiment, an ECU having a PN function is not connected to the first communication bus 41. On the other hand, in the in-vehicle network system 100, an ECU having a PN function may be connected to the first communication bus 41 to which the first device 61 is connected.

As described above, an ECU having a PN function does not shift to the operation state unless the ECU in the operation state transmits the PN message 51 addressed to itself even if another ECU having a PN function is in the operation state. Therefore, even if an ECU having a PN function is connected to the first communication bus 41, a message requesting operation is not transmitted to the first communication bus 41, and a message requesting operation is transmitted to the second communication bus 42.

In the in-vehicle network system 100 according to the above-described embodiment, a plurality of first devices 61 are connected to the first communication bus 41. On the other hand, only one first device 61 may be connected to the first communication bus 41.

In the in-vehicle network system 100 according to the above-described embodiment, the second device 62 performs failure determination on the plurality of first devices 61. On the other hand, the second device 62 may have only one first device 61 to be subjected to failure determination.

In the in-vehicle network system 100 according to the above-described embodiment, the relay device 10 is connected to the first communication bus 41, the second communication bus 42, and the third communication bus 43. The relay device may include a plurality of ECU. For example, in the in-vehicle network system 100, one ECU corresponding to the respective communication buses may be installed, and ECU may communicate with each other to serve as the relay device 10 in the above-described embodiment.

ECU are connected to the first communication bus 41, the second communication bus 42, and the third communication bus 43 in the in-vehicle network system 100 one by one. Hereinafter, an ECU that is connected to the communication buses and serves as the relay device 10 will be referred to as a control ECU.

Each control ECU sends a message to the other control ECU that is received from an ECU having an NM function connected to the corresponding communication bus. Further, each control ECU transmits a message received from another control ECU to an ECU having an NM function connected to a corresponding communication bus. As described above, the control ECU can serve as the relay device 10 by communicating with other control ECU.

Each control ECU manages a list of state information of the ECU not having a PN function connected to a corresponding communication bus. When the stored list is updated, the control ECU transmits the updated list to another control ECU. The control ECU that has received the information in the listing transmits the information to the corresponding communication buses.

In this way, in the in-vehicle network system 100, a plurality of control devices can act on behalf of the relay device 10.

What is claimed is:

1. A relay device in an in-vehicle network system comprising:
as an electronic control unit having a network management function that shifts from a standby state to an operation state when operation is requested through a message, the standby state being when communication is not performed and the operation state being when communication is able to be performed,
a first device,
a second device that executes a failure determination determining the first device has failed when a periodic reception of the message is interrupted, the message being periodically transmitted by the first device, and
a third device having, in addition to the network management function, a partial network function that does not shift from the standby state to the operation state when operation is requested through the message and when the message is not addressed to itself;
a first communication bus connected to the first device; and
a second communication bus connected to the second device and the third device, wherein the relay device is configured to
relay the message exchanged between the first communication bus and the second communication bus in the in-vehicle network system,
acquire state information that includes information indicating whether the first device is in either the standby state or the operation state, and
transmit the acquired state information to the second device.

2. The relay device according to claim 1, wherein:
in the in-vehicle network system, the first communication bus is connected to a plurality of the first devices; and
the relay device is configured to
acquire the state information for each one of the first devices and
collectively transmit the acquired plurality of state information to the second device as one list.

3. The relay device according to claim 1, wherein when the first device shifts from the operation state to the standby state, at a timing at which the first device that periodically transmitted the message is next expected to transmit the message, the relay device is configured to transmit the state information to the second device instead of to the first device, the state information indicating the first device is in the standby state.

4. An in-vehicle network system comprising:
as an electronic control unit having a network management function that shifts from a standby state to an operation state when operation is requested through a message, the standby state being when communication is not performed and the operation state being when communication is able to be performed,
a first device,
a second device that executes a failure determination determining the first device has failed when a periodic reception of the message is interrupted, the message being periodically transmitted by the first device, and
a third device having, in addition to the network management function, a partial network function that does not shift from the standby state to the operation state when operation is requested through the message and when the message is not addressed to itself;
a first communication bus connected to the first device;
a second communication bus connected to the second device and the third device; and
a relay device that relays the message exchanged between the first communication bus and the second communication bus, wherein
the relay device is configured to
acquire state information that includes information indicating whether the first device is in either the standby state or the operation state and
transmit the acquired state information to the second device, and
when the second device receives the state information indicating the first device is in the standby state during execution of the failure determination, the second device stops the failure determination for the first device.

5. The in-vehicle network system according to claim 4, wherein when the second device receives the state information from the relay device after the failure determination is stopped, the second device restarts the failure determination for the first device when the received state information indicates the first device is in the operation state.
